(19) United States
(12) Patent Application Publication
(10) Pub. No.: US 2015/0256019 A1
(43) Pub. Date: Sep. 10, 2015

(54) KINETIC ENERGY CAPTURE APPARATUS AND SYSTEM

(71) Applicant: Daniel Lee Pate, San Diego, CA (US)

(72) Inventor: Daniel Lee Pate, San Diego, CA (US)

(21) Appl. No.: 14/605,936

(22) Filed: Jan. 26, 2015

Related U.S. Application Data
(60) Provisional application No. 61/931,664, filed on Jan. 26, 2014.

(51) Int. Cl. H02J 7/00; H02J 5/00; H02J 7/32

(52) U.S. Cl. CPC H02J 7/0068; H02J 7/328; H02J 5/00

(57) ABSTRACT

A novel method, apparatus, and system are disclosed for a kinetic energy capture and dispensing system. The kinetic energy capture and dispensing system comprises a mechanical motion source interface member, a switching circuit element, and a microprocessor, adapted to power either an AC powered device and/or a DC powered device. The kinetic energy capture and dispensing system is further adapted to supplement power to the external powered device via a household AC power supply.

This application claims the benefit of priority to pending provisional patent entitled, KINETIC ENERGY CAPTURE APPARTAUS AND SYSTEM, filed Jan. 26, 2014, Ser. No. 61/931,664, to Pate, and is hereby incorporated by reference in its entirety.

### BACKGROUND

1. Field

The present disclosure generally relates to an apparatus and system for capturing, storing and dispensing a quantity of kinetic mechanical energy, converted to electrical energy, to optionally power an alternating current device, a direct current device or to supply power to an energy grid.

2. Related Art

Exploding population densities coupled with rapidly diminishing resources drives energy efficiency, research, development, and recycling. Large-scale power grids around the world are often precariously balanced and on the edge of failure, as recently seen in India, leaving over 650 million people without power for days during extremely hot weather, causing casualties. Moreover, as there was no alternative method by which consumers could generate their own electricity, electrical grid customers were required to wait until the grid came back online. This issue is not limited to developing nations such as India, as illustrated by a recent sweeping power outage leaving tens of millions without power throughout several states in the southwestern United States.

Demand for energy is increasing as more electronics device innovations permeate society and as human populations expand geometrically around the world. Solar panels, windmills and other renewable energy generation devices have enabled some people to reduce dependency on a local power grid, and in some cases completely remove themselves from the grid. Each form of renewable resource has inherent limitations, and is not generally available on demand. Solar panels require sunshine to function properly, and are therefore limited in regions having sunlight, and certainly not collecting energy during nighttime. Windmills require large amounts of wind to effectively capture energy, which is largely unpredictable and unreliable. Often long transmission lines are required to distribute power from windmills, as vast distances must generally be crossed to deliver such energy, resulting in significant power losses.

It would be useful if there were a system by which electricity consumers could create their own power at will, to at least provide basic energy needs. As society has become increasingly aware of the strong correlation between adequate exercise and long-term health, home exercise equipment is increasingly popular, such as for example stationary bicycles, stair climbers, and the like. Substantial quantities of mechanical energy are generated and unharnessed by such exercise equipment.

The present teachings solve these problems, provide valuable savings to consumers for energy costs, and allow greater autonomy for such consumers even in times when the power grid fails, as will now be described.

### SUMMARY

Embodiments of the present teachings comprise a kinetic energy capture and dispensing system, adapted to capture energy generated by a mechanical motion source. The system has a mechanical motion source interface member, adapted to interface with the mechanical motion source and is adapted to facilitate flow of electromagnetic energy generated by the mechanical motion source. The kinetic energy capture and dispensing system further has a switching circuit element, operatively coupled to the mechanical motion source interface member, adapted to switch between providing flowing electromagnetic energy to an energy storage device or an energy dispensing device, wherein the energy storage device is adapted to store electrical energy generated by the mechanical motion source, wherein the energy dispensing device is adapted to supply power to optionally an alternating current powered device, a direct current powered device, or an energy grid, wherein the energy dispensing device is operatively coupled to a standard 120 volt household power supply. The kinetic energy capture and dispensing system further has a microprocessor element, adapted to control the kinetic energy capture and dispensing system, adapted to switch the switching circuit element between the energy storage device or the energy dispensing device, and is further adapted to measure energy storage capacity in the energy storage device, also adapted to control energy flow from the energy dispensing device, and adapted to supplement dispensed energy with alternating current voltage from the standard 120 volt household power supply, lastly, the kinetic energy storage device is adapted to control energy flow into the energy storage grid.

### BRIEF DESCRIPTION OF THE DRAWINGS

Embodiments of the present disclosure will be more readily understood by reference to the following figures, in which like reference numbers and designations indicate like elements.

FIG. 1a illustrates a block diagram for a kinetic energy capture apparatus and system having a single motion source, according to one embodiment of the present teachings.

FIG. 1b illustrates a block diagram for a kinetic energy capture apparatus and system having a plurality of motion sources, according to one embodiment of the present teachings.

FIG. 1c illustrates a block diagram for a kinetic energy capture apparatus and system having a generator, according to one embodiment of the present teachings.

FIG. 1d illustrates a block diagram for a kinetic energy capture apparatus and system having a generator and a gearbox, according to one embodiment of the present teachings.

FIG. 1e illustrates a block diagram for a kinetic energy capture apparatus and system having a generator connected to a energy dispensing device, according to one embodiment of the present teachings.

FIG. 1f illustrates an alternating current to direct current converter, according to one embodiment of the present teachings.

FIG. 1g illustrates a voltage summing circuit, according to one embodiment of the present teachings.

### DETAILED DESCRIPTION

### Overview

The present disclosure provides instructions for how to make and use a kinetic energy capture apparatus and system, which captures energy generated by a user (e.g., humans, animals). Electrical energy is delivered from a mechanical motion source operated by a user, conditioned as necessary, and either stored or dispensed as required by an external powered device.

As used herein, the terms “microprocessor” and “digital processor” are meant generally to include all types of digital processing devices including, without limitation, digital signal processors (DSPs), reduced instruction set computers (RISC), general purpose (CISC) processors, microprocessors, gate arrays, (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

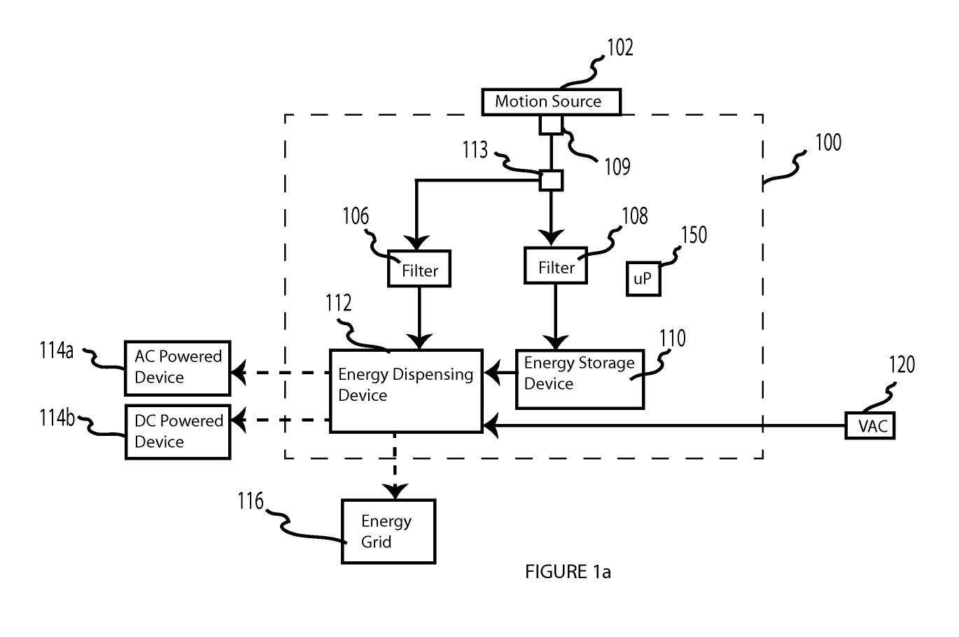

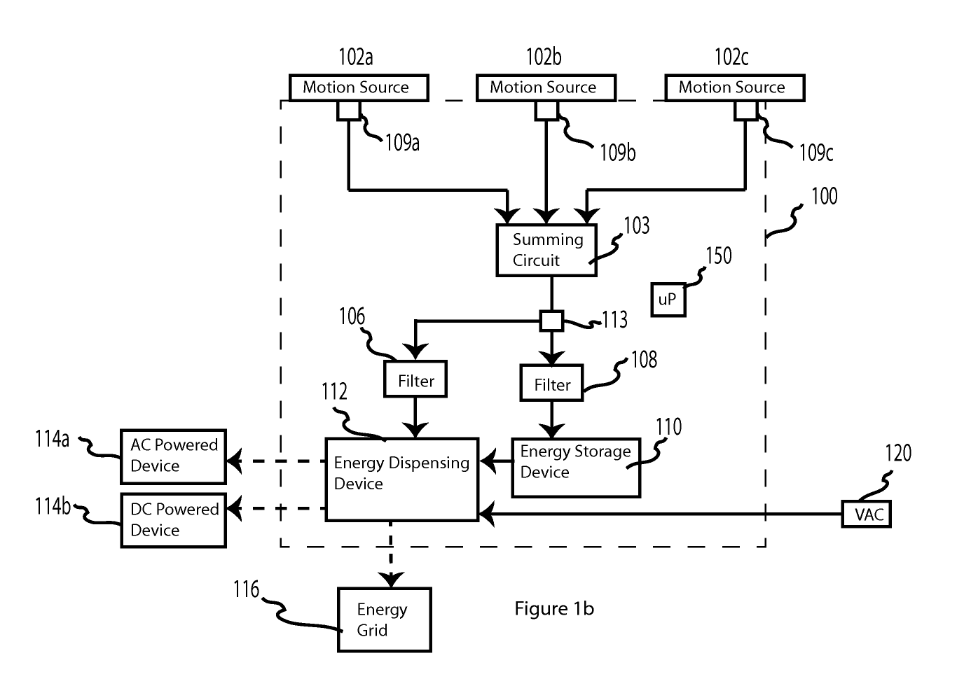

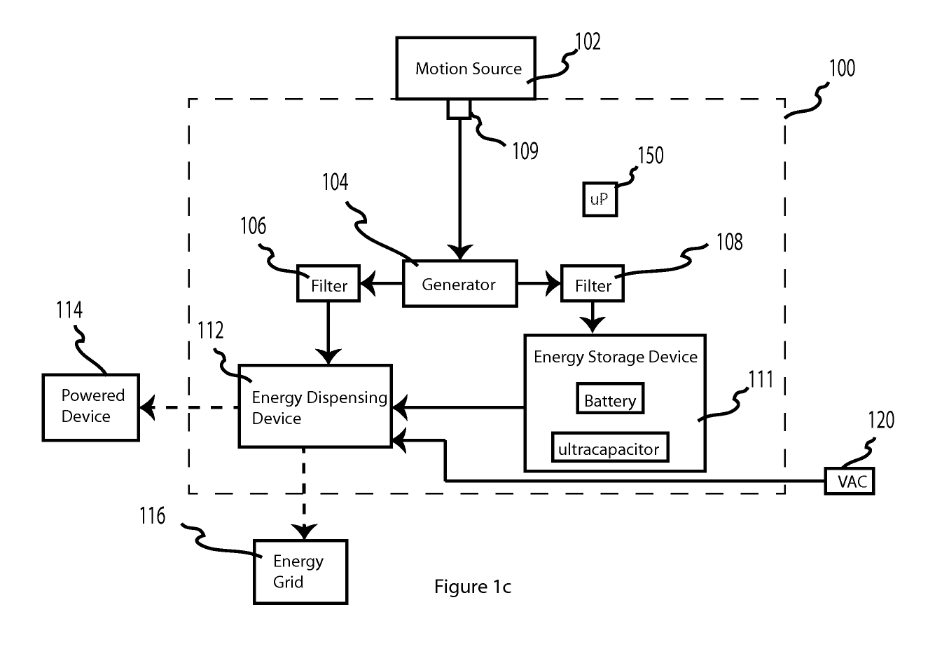

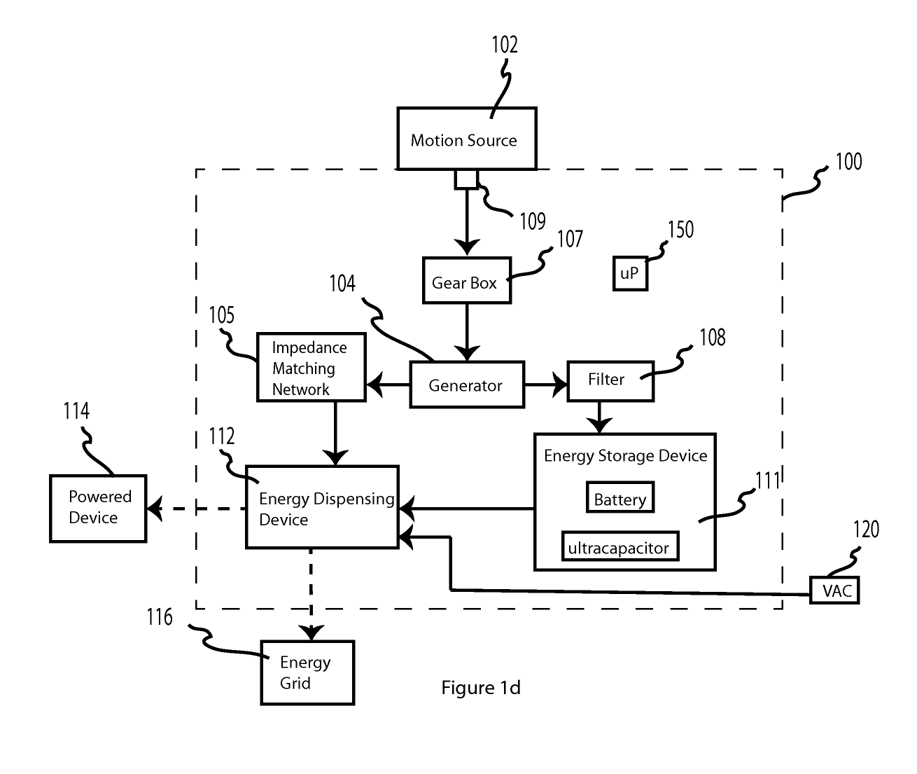

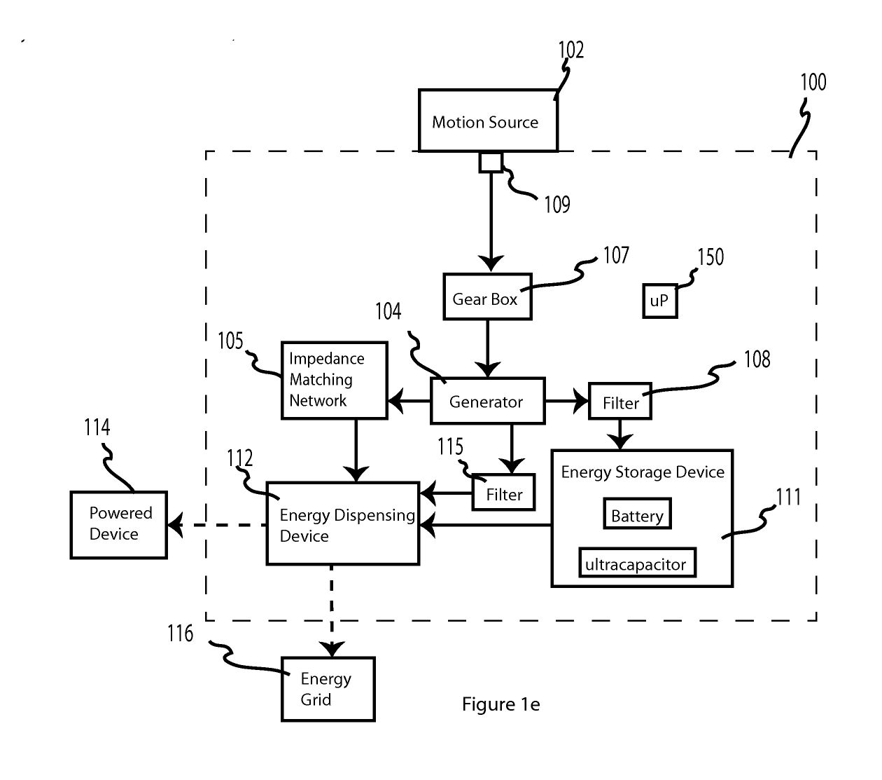

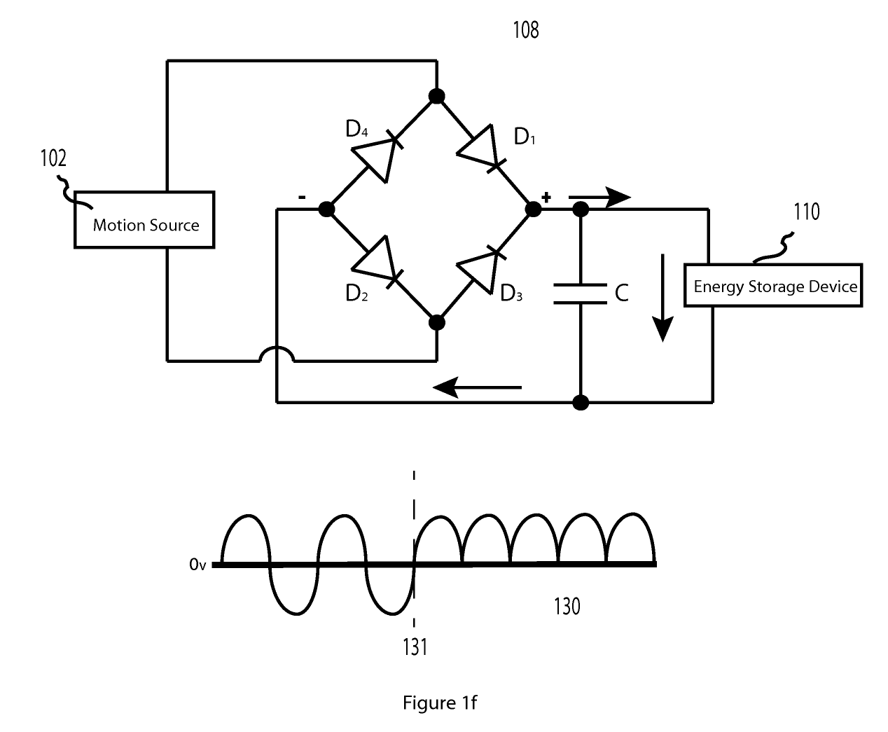

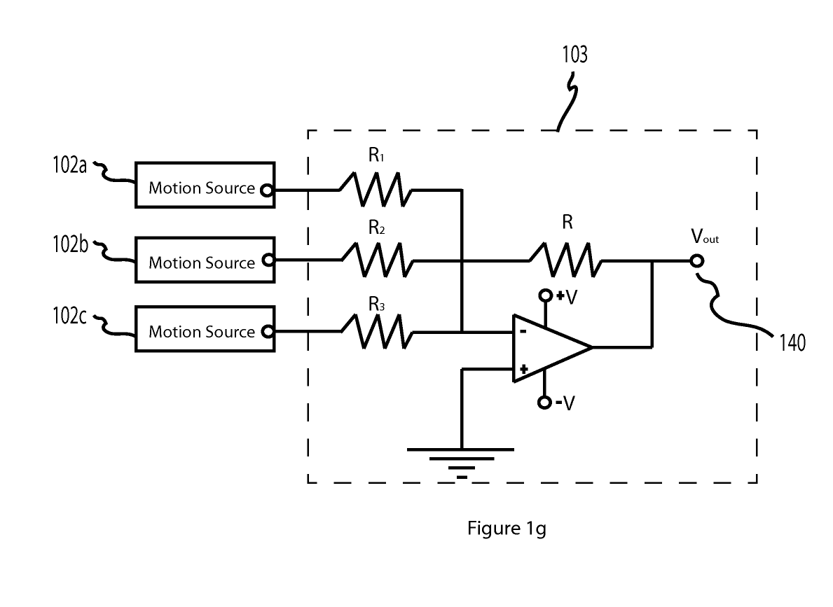

Referring now to FIG. 1 a, in one embodiment of the present teachings, a kinetic energy capture and dispensing system 100 is disclosed. The kinetic energy capture and dispensing system 100 is designed to be operatively coupled to a mechanical motion source 102, accepting a quantity of electrical energy generated thereby. In one embodiment, the mechanical motion source 102 comprises a stationary bicycle having a mechanical energy to electrical energy conversion apparatus thereon. Variations for the mechanical motion source 102 include literally any form of exercise equipment including, but not limited to, a stationary stair climber, a treadmill, and an arm crank, adapted to convert mechanical energy into electrical energy.

A mechanical motion source interface member 109 operatively couples to the mechanical motion source 102 and is adapted to accept the quantity of electrical energy generated by the mechanical motion source 102. The mechanical motion source interface member 109 is adapted to accept a varying range of electrical power therein, as the mechanical motion source 102 output will vary dependent upon the user's exerted mechanical energy. In one embodiment, the mechanical motion source 102 outputs energy in the form of an alternating electrical current waveform, which may optionally vary in time in either amplitude and/or phase, for which the mechanical motion source interface member 109 is adapted to accept and pass either raw or filtered waveforms into the kinetic energy capture and dispensing system 100. If the mechanical motion source interface member 109 filters incoming waveforms, a sequence of feedback loops compensating for phase corrections and amplitude variations equalize an output waveform, suitably formatted for inputting into the kinetic energy capture and dispensing system 100. The mechanical motion source interface member 109 is adapted to facilitate flow of electromagnetic energy generated by a motion source.

A switching circuit element 113, operatively coupled to the mechanical motion source interface member 109, is adapted to switch between providing flowing electromagnetic energy to an energy storage device 110 or an energy dispensing device 112. In one embodiment, the switching circuit element 113 is adapted to accept either alternating current or direct current electrical energy. In one embodiment, a microprocessor 150 is adapted to control electrical energy routing between either the energy storage device 110 or the energy dispensing device 112. An optional energy storage filter 108 conditions and/or filters electrical energy flowing from the switching circuit element 113 into the energy storage device 110. An optional energy dispensing filter 106 conditions and/or filters electrical energy flowing from the switching circuit element 113 into the energy dispensing device 112. The microprocessor 150 may optionally be used to control conditioning and filtration.

The microprocessor 150 operates to monitor energy stored in the energy storage device 110 and disperse such energy via the energy dispensing device 112 as required by attached devices, such as for example an alternating current (“AC”) powered device 114a and/or a direct current (“DC”) powered device 114b. The microprocessor 150 functions to control energy storage levels in the energy storage device 110. In one embodiment, a household AC power supply 120 is operatively coupled to the kinetic energy capture and dispensing system 100 to supplement power supply requirements of the AC powered device 114a and/or a DC powered device 114b. The microprocessor 150 is operatively coupled to the energy dispensing device 112 and monitors energy levels necessary for powering attached AC powered devices 114a and DC powered devices 114b, further monitors incoming energy dynamically available from the mechanical motion source 102 and energy available from the energy storage device 110, whereby the microprocessor 150 is adapted to supplement energy from the household AC power supply 120 as needed. That is, if the AC powered device 114a and/or the DC powered device 114b require energy greater than the quantity of energy dynamically generated by the mechanical motion source and the energy storage device combined, then the microprocessor 150 functions to trickle an amount of energy from the household AC power supply 120 equal to the difference required to power such devices. In one embodiment, energy generated and/or stored by the kinetic energy capture and dispensing system 100 may transmit energy into an energy grid 116. The energy grid 116 is generally a mass power grid delivering electrical energy to the public.

Referring now to FIG. 1b and FIG. 1g, a kinetic energy capture and dispensing system 100, having a plurality of mechanical motions sources is disclosed. In one embodiment, the kinetic energy capture and dispensing system 100 comprises three mechanical motion sources, 102a, 102b, and 102c, each having a mechanical motion source interface member 109a, 109b, and 109c respectively coupled thereto as illustrated in FIG. 1b. Each respective mechanical motion source interface member 109a, 109b, and 109c function substantially the same as described above with respect to the mechanical motion source interface member 109. Each of the mechanical motion source interface members 109a, 109b, and 109c operatively couple to a summing circuit 103. In one illustrative exemplary embodiment, shown in FIG. 1g, energy generated by each of the mechanical motion sources 102a, 102b, and 102c connect to the summing circuit 103, thereby combining and aggregating all electrical energy flowing therefrom the mechanical motion sources 102a, 102b, and 102c at a node 140, having a voltage of Vout. It will be appreciated that additional components may be required to align incoming energy phase and amplitude, such as for example inductive and/or capacitive components, to generate a coherent Vout value appropriate for energy storage and/or energy dispensing requirements, as monitored and controlled by a microprocessor 150. The microprocessor 150 monitors system requirements as determined by an AC powered device 114a and/or a DC powered device 114b, and routes energy via an energy dispensing device 112 and/or an energy storage device 110. A switching circuit element 113, operatively coupled to the summing circuit 103 is adapted to route such required energy, as controlled by the microprocessor 150.

Referring now to FIG. 1c, a kinetic energy capture and dispensing system 100 is disclosed, wherein an energy storage device 111 comprises a battery and/or an ultracapacitor. In one embodiment, the battery and ultracapacitor are arranged in parallel, such that the energy storage device 111 may discharge energy either from the battery or the ultracapacitor, as may be required as determined by a microprocessor 150, which monitors energy requirements from a powered device 114 and/or an energy grid 116. It will be appreciated that if required, the ultracapacitor may rapidly discharge some or all of its energy, should such rapid energy discharge be required, as determined by the microprocessor 150. Furthermore, for slower energy discharge, the battery may be sourced. It will be appreciated that energy may be drawn from either the battery or ultracapacitor, alone or in parallel, as required. In one embodiment, a mechanical motion source 102, operatively coupled to a mechanical motion source interface member 109, is connected to a generator 104. The generator 104 operates to convert mechanical energy into electrical energy, which is then filtered via a filter 106 for transferring to an energy dispensing device 112 and/or filtered by a filter 108 for transfer to the energy storage device 111. A household AC power supply 120 is operatively coupled to the kinetic energy capture and dispensing system 100 to supplement power requirements of the attached powered device(s) 114.

Referring now to FIG. 1d, in one embodiment, a kinetic energy capture and dispensing system 100 is disclosed, comprising a gear box 107, an impedance matching network 105, and a generator 104. In this embodiment, the kinetic energy capture and dispensing system 100 operates substantially the same as described above, with respect to other embodiments, of the present teachings. In this embodiment, however, the gear box 107 is operatively coupled to a mechanical motion source interface member 109, such that incoming rotational energy may be converted to accommodate one or more system power requirements, as determined by a microprocessor 150. For example, phase or frequency of rotational mechanical energy generated by a mechanical motion source 102 may optionally be shifted to accommodate system requirements for power, as controlled by the microprocessor 150. The impedance matching network 105 operates to minimize electrical energy losses in the kinetic energy capture and dispensing system 100 by passively or actively matching an output impedance of the generator 104 to an input impedance of an energy dispensing device 112.

Referring now to FIG. 1e, in one embodiment a kinetic energy capture and dispensing system 100 is disclosed. In this illustrative exemplary embodiment, electrical energy output from a generator 104 may optionally be routed through an impedance matching network 105 and/or a filter 115, as required to power a powered device 114, as monitored and determined by a microprocessor 150.

In one embodiment, an energy storage device 110 or 111 comprises a graphene sheet upon which a plurality of carbon nanotubes may be grown. Such embodiments increase total surface area of an ultracapacitor electrode, which is directly correlated to an increased energy density. Furthermore, there is no resistance for electrons transitioning between the graphene sheet and the plurality of carbon nanotubes, therefore minimizing energy losses.

Referring now to FIG. 1f, in one embodiment a kinetic energy capture and dispensing system 100 further comprises an alternating current to direct current (“AC to DC”) circuit 108, adapted to format incoming electrical energy appropriate for storing in an energy storage device 110 (or optionally an energy storage device 111). As illustrated in graph 130, an incoming alternating current waveform is converted by the AC to DC circuit 108 at a point 131, to create a steady state constant voltage, which is further stabilized by a capacitor “C”.

Embodiments of the present teachings may be used to power literally any kind of a powered device 114, such as for example a television, a computer, a cellular telephone.

Those skilled in the art will appreciate that the present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The microprocessor described herein above may operate in a networked environment using logical connections to one or more remote computers. These logical connections can be achieved using a communication device that is coupled to or be a part of the computer; the present teachings are not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

When used in a LAN-networking environment, the microprocessor is connected to the local network through a network interface or adapter, which is one type of communications device. When used in a WAN-networking environment, the computer typically includes a modem, a type of communications device, or any other type of communications device for establishing communications over the wide area network, such as the Internet.

The foregoing description illustrates exemplary implementations, and novel features, of aspects of a kinetic energy capture and dispensing system. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. A kinetic energy capture and dispensing system, adapted to capture energy generated by a motion source, comprising:
(a.) a mechanical motion source interface member, adapted to interface with the motion source, adapted to facilitate flow of electromagnetic energy generated by the motion source;
(b.) a switching circuit element, operatively coupled to the mechanical motion source interface member, adapted to switch between providing flowing electromagnetic energy to an energy storage device or an energy dispensing device, wherein the energy storage device is adapted to store electrical energy generated by the mechanical motion source, wherein the energy dispensing device is adapted to supply power to optionally an alternating current powered device, a direct current powered device, or an energy grid, wherein the energy dispensing device is operatively coupled to a standard 120 volt household power supply, and;
(c.) a microprocessor element, adapted to control the kinetic energy capture and dispensing system, adapted to switch the switching circuit element between the energy storage device or the energy dispensing device, adapted to measure energy storage capacity in the energy storage device, adapted to control energy flow from the energy dispensing device, adapted to supplement dispensed energy with alternating current voltage from the standard 120 volt household power supply, adapted to control energy flow into the energy storage grid.

2. A kinetic energy capture and dispensing system, adapted to capture energy generated by a plurality of motion sources, comprising:
(a.) a plurality of mechanical motion source interface members, adapted to interface with the plurality of motion sources, adapted to facilitate flow of electromagnetic energy generated by the plurality motion sources;
(b.) a summing circuit, adapted to aggregate voltages sourced from the plurality of motion sources;
(c.) a switching circuit element, operatively coupled to the summing circuit, adapted to switch between providing flowing electromagnetic energy to an energy storage device or an energy dispensing device, wherein the energy storage device is adapted to store aggregate voltages from the summing circuit, wherein the energy dispensing device is adapted to supply power to optionally an alternating current powered device, a direct current powered device, or an energy grid, wherein the energy dispensing device is operatively coupled to a standard 120 volt household power supply, and;
(c.) a microprocessor element, adapted to control the kinetic energy capture and dispensing system, adapted to switch the switching circuit element between the energy storage device or the energy dispensing device, adapted to measure energy storage capacity in the energy storage device, adapted to control energy flow from the energy dispensing device, adapted to supplement dispensed energy with alternating current voltage from the standard 120 volt household power supply, adapted to control energy flow into the energy storage grid.

3. The kinetic energy capture and dispensing system of claim 1, wherein the energy storage device element comprises a battery.

4. The kinetic energy capture and dispensing system of claim 3, wherein the energy storage device element further comprises an ultracapacitor.

5. The kinetic energy capture and dispensing system of claim 4, wherein the energy storage device element comprises a graphene sheet.

6. The kinetic energy capture and dispensing system of claim 5, wherein the energy storage device element further comprises carbon nanotubes.

7. The kinetic energy capture and dispensing system of claim 2, wherein the energy storage device element comprises a battery.

8. The kinetic energy capture and dispensing system of claim 7, wherein the energy storage device element further comprises an ultracapacitor.

9. The kinetic energy capture and dispensing system of claim 8, wherein the energy storage device element comprises a graphene sheet.

10. The kinetic energy capture and dispensing system of claim 9, wherein the energy storage device element further comprises carbon nanotubes.

11. The kinetic energy capture and dispensing system of claim 1, further comprising a generator element for converting mechanical energy into electrical energy.

12. The kinetic energy capture and dispensing system of claim 2, further comprising a generator element for converting mechanical energy into electrical energy.

13. The kinetic energy capture and dispensing system of claim 3, further comprising a generator element for converting mechanical energy into electrical energy.

14. The kinetic energy capture and dispensing system of claim 4, further comprising a generator element for converting mechanical energy into electrical energy.

15. The kinetic energy capture and dispensing system of claim 7, further comprising a generator element for converting mechanical energy into electrical energy.

16. The kinetic energy capture and dispensing system of claim 8, further comprising a generator element for converting mechanical energy into electrical energy.

17. The kinetic energy capture and dispensing system of claim 11, further comprising a gear box element.

18. The kinetic energy capture and dispensing system of claim 12, further comprising a gear box element.

19. The kinetic energy capture and dispensing system of claim 13, further comprising a gear box element.

20. The kinetic energy capture and dispensing system of claim 16, further comprising a gear box element.
